(19) United States
(12) Patent Application Publication
(10) Pub. No.: US 2009/0050625 A1
(43) Pub. Date: Feb. 26, 2009

(54) FUEL INLET DEVICE AND PART THEREFOR

(75) Inventor: Richard Nigel Fowler, Newport (GB)

Correspondence Address: MERCHANT & GOULD PC, P.O. BOX 2903, MINNEAPOLIS, MN, 55402-0903, US

(73) Assignee: TruckProtect Limited, Newport (GB)

(21) Appl. No.: 11/842,665

(22) Filed: Aug. 21, 2007

(51) Int. Cl. B60K 15/04; B67D 5/37; F16L 25/00

(52) U.S. Cl. 220/86.2; 141/311 R; 285/420

(57) ABSTRACT

A fuel tank inlet device is for attachment to a fuel tank or filler neck. The fuel tank or filler neck includes a filler opening, a fuel tank or filler neck abutment surface and one or more projections extending inwardly into the filler opening. The fuel tank inlet device includes a clamping member and a mounting portion, the mounting portion being provided with a first clamping surface. The fuel tank inlet device is provided with an inlet for the ingress of fuel and an outlet for the egress of fuel into a fuel tank. One or both of the mounting portion and the clamping member is movable relative to the other of the mounting portion and the clamping member from a non-clamping configuration to a clamping configuration. In use, the clamping member engages a projection and the first clamping surface, engages with the fuel tank or filler neck abutment surface so as to secure the device to the fuel tank or filler neck.

### TECHNICAL FIELD

The present invention relates to a fuel tank inlet device which may typically be mounted in the inlet of a fuel tank of a vehicle, and a part for such a fuel tank inlet device which part enables the fuel tank inlet device to be readily mounted in the inlet of a fuel tank.

### BACKGROUND OF THE INVENTION

Fuel tank inlet devices are well known to those skilled in the art. They are typically mounted to a fuel tank or filler neck in one of many ways, including gluing or by using bolts. Bayonet type fittings have also been used. In such bayonet fittings, a male part of the fitting is provided as part of the device. The male parts mate with apertures or recesses provided in the fuel tank or filler neck. The aperture or recess is typically formed by a camming surface. The camming surface provides a recess that is wedge shaped, with a large opening to initially receive the male part. Subsequent rotation of the device after insertion of the male parts into the recess or aperture causes the projections on the device to be moved against the camming surface. This camming surface allows insertion and rotation of the device and is arranged to move the device into engagement with the filler neck or fuel tank. The operation of the bayonet arrangement relies on the camming surface provided on part of the neck or tank.

In many countries, the filler neck or fuel tank is not provided with such a camming arrangement. Devices with conventional male parts of bayonet fittings may not be satisfactorily mounted on such filler necks or fuel tanks without difficulty.

### SUMMARY OF THE INVENTION

The present invention provides a fuel tank inlet device which mitigates one or more of the prior art problems.

In accordance with a first aspect of the present invention there is provided a fuel tank inlet device for attachment to a fuel tank or filler neck, the fuel tank or filler neck comprising a filler opening, a fuel tank or filler neck abutment surface and one or more projections extending inwardly into the filler opening,

the fuel tank inlet device comprising a clamping member and a mounting portion, the mounting portion being provided with a first, clamping surface,
the fuel tank inlet device being provided with an inlet for the ingress of fuel and an outlet for the egress of fuel into a fuel tank
one or both of the mounting portion and the clamping member being movable relative to the other of the mounting portion and the clamping member from:
a non-clamping configuration; to
a clamping configuration in which, in use, the clamping member engages a projection and said first, clamping surface, in use, engages with the fuel tank or filler neck abutment surface so as to secure the device to the fuel tank or filler neck.

In the clamping configuration, a portion of the filler neck or fuel tank is typically clamped between the mounting portion and the clamping member. In the clamping configuration, a surface of the clamping member typically abuts the projection, said surface typically being a flat planar surface.

In certain embodiments of the invention, in the non-clamping configuration the clamping member is remote from the first, clamping surface provided by the mounting portion.

In certain embodiments of the invention, in the clamping configuration the clamping member is less remote from the first, clamping surface provided by the mounting portion. In this way, movement from the non-clamping configuration to the clamping configuration may cause a decrease in the separation of the clamping member and the first, clamping surface provided by the mounting portion. For example, in the clamping configuration the clamping member may be proximal to the first, clamping surface provided by the mounting portion.

The device of the present invention provides a suitable means for attaching the device to a fuel tank or filler neck.

In certain embodiments, the clamping member may be movable relative to the mounting portion from the non-clamping configuration to the clamping configuration.

In other embodiments, the mounting portion may be movable relative to the clamping member from the non-clamping configuration to the clamping configuration.

In other further embodiments, the clamping member and the mounting portion may both be movable from the non-clamping configuration to the clamping configuration.

Those skilled in the art will realize that the present invention could be arranged to function when used with known types of fuel tank or filler neck. Alternatively, in some embodiments, the fuel tank or filler neck may be specially arranged to function with the fuel tank inlet device of the invention.

The device may be arranged so that, once the device has been fitted to a fuel tank or filler neck, movement of one or both of the mounting portion and the clamping member from the clamping configuration to the non-clamping configuration may be resisted.

Alternatively, the device may be arranged so that, once the device has been fitted to a fuel tank or filler neck, movement of one or both of the mounting portion and the clamping member from the clamping configuration to the non-clamping configuration is permitted.

The device of the present invention is suitable for use with fuel tanks provided with a filler neck or fuel tanks which are not provided with a filler neck. Those skilled in the art will realise that a filler neck may not be integral with a fuel tank; the filler neck may be fitted to a fuel tank, for example.

The mounting portion may comprise a seal member. The seal member may provide the first, clamping surface.

The first, clamping surface may be suitable for abutment with an annular surface. The filler neck or fuel tank abutment surface may be annular, and may be curved in cross-section. The filler neck or fuel tank abutment surface may, therefore, be hemi-toroidal. The filler neck or fuel tank abutment surface may be provided by a lip, which may be an annular lip. The first, clamping surface may be suitable for abutment with such fuel tank or filler neck abutment surfaces.

The first, clamping surface may be defined by a recess. The recess may be annular. The first, clamping surface may be curved in cross-section. The first, clamping surface may be concave.

The mounting portion may be provided as part of an upper part of a device. The mounting portion may be provided by a flange or a collar.

The fuel inlet device may comprise the mounting portion and a portion for insertion into the filler neck or fuel tank.

The fuel inlet device may comprise the mounting portion and a substantially tubular portion extending away from the mounting portion. The tubular portion may be arranged so that it may receive fuel from a dispensing apparatus. The substantially tubular portion may be provided with one or more outlets for egress of fuel from the device into a fuel tank. The tubular portion may be elongate.

The mounting portion may be associated with a fuel inlet body for the receipt of fuel. For example, the mounting portion may be attached to a fuel inlet body (for example, by welding, screws or the like). In this case, movement of the mounting portion may provide movement of the fuel inlet body. The mounting portion may be provided as part of a fuel inlet body for the receipt of fuel.

The fuel inlet body may comprise a substantially tubular portion which extends away from the mounting portion. The tubular portion may be arranged so that it may receive fuel from a dispensing apparatus. The substantially tubular portion may be provided with one or more outlets for egress of fuel from the device into a fuel tank. The tubular portion may be elongate.

The fuel tank inlet device may typically mate with the fuel tank or filler neck via the filler opening. For example, if the device comprises a tubular portion extending away from the mounting portion, the tubular portion may extend into the fuel tank or filler neck via the filler opening.

The device may be adapted to inhibit theft of liquid fuel from a fuel tank to which the device is attached. This may be achieved by providing a device which inhibits insertion of a siphon tube into the fuel tank through the device. This may be achieved, for example, by the device being in the form of a cage, or by providing a device comprising a tubular portion which is provided with one or more guard members which inhibit insertion of a siphon tube into the fuel tank through the device.

The device may be provided with a plurality of clamping members. The device may typically be provided with three or four clamping members. The number of clamping members may typically correspond to the number of projections provided on the filler neck or fuel tank.

One or both of the mounting portion and more than one (and preferably all) clamping member(s) may be movable relative to the other of the mounting portion and the more than one (and preferably all) clamping member(s) from the non-clamping configuration to the clamping configuration.

At least one (and optionally more than one and further optionally all) clamping member(s) may be arranged to engage with a respective projection when the respective clamping member is in the clamping configuration. If there is more than one clamping member, optionally each clamping member engages with a respective (and different) projection. Optionally, at least one (and optionally more than one and further optionally all) clamping member(s) may be arranged to engage with the underside of a respective projection.

At least one (and optionally more than one and further optionally all) clamping member(s) may be provided by a clamping member carrier. At least one (and optionally more than one and further optionally all) clamping member(s) may be in the form of a flange which projects from a body of the clamping member carrier. The flange may project outwardly from the body of the clamping member carrier. At least one (and optionally more than one and further optionally all) clamping member(s) may be integrally formed with the body of the clamping member carrier (for example, by machining the clamping member carrier and the clamping member from one piece of metal). The clamping member carrier facilitates the relative movement from the non-clamping to the clamping configurations. A clamping member carrier also facilitates the use of more than one clamping member.

The body of the clamping member carrier may be substantially annular.

If the device comprises a fuel inlet body or a tubular portion extending away from the mounting portion (the tubular portion optionally being provided as part of a fuel inlet body), the clamping member carrier may be adapted to be received around the periphery of a portion of the fuel inlet body or tubular portion. For example, the clamping member carrier may be annular, a portion of the fuel inlet body or the tubular portion being receivable into the aperture formed by the annulus.

The clamping member carrier may be readily detachable from the fuel inlet body or tubular portion. This may facilitate the use of one clamping member carrier with one of many suitably adapted fuel inlet bodies.

The clamping member carrier may be provided with a mounting configuration for mating with a corresponding mounting configuration on the fuel inlet body or tubular portion. The mounting configuration and the corresponding mounting configuration facilitate the mounting of the clamping member carrier onto the fuel inlet body or tubular portion. The mounting configuration and the corresponding mounting configuration may each be in the form of a screw thread.

The corresponding mounting configuration may be provided around the external periphery of a part of the fuel inlet body or tubular portion. The fuel inlet body may comprise a part for insertion into a fuel tank or filler neck. The corresponding mounting configuration may be provided around the external periphery of the part for insertion into a fuel tank or filler neck.

The clamping member carrier may be provided with the mounting configuration on an internal periphery of the clamping member carrier body. This is particularly useful if the clamping member carrier body is annular.

In the case where the clamping member carrier body is substantially annular, the clamping member carrier body has a longitudinal axis orthogonal to the annulus and the clamping member carrier body has a height in the direction parallel to the longitudinal axis. The mounting configuration may optionally not be provided over the whole height of the clamping member carrier body. The mounting configuration may be provided over 30-70% of the height of the clamping member carrier body.

The provision of a screw thread on both the fuel inlet body (or tubular portion) and the clamping member carrier body facilitates the device to be readily mounted to a filler neck or fuel tank.

The device may be provided with at least one stop member (and optionally more than one stop member) for inhibiting rotational motion of the clamping member relative to the filler neck or fuel tank. Typically, at least one (and optionally more than one and further optionally all) stop member(s) may permit limited rotational motion so that at least one clamping member may undergo rotational motion into a position opposite a projection of the filler tank or neck. The at least one stop member would inhibit further rotational motion by, for example, abutting a part of the filler neck or fuel tank.

The device may be provided with one stop member for each clamping member. The stop members may be associated with a respective clamping member.

At least one (and optionally more than one and further optionally all) stop member(s) may be provided by the clamping member carrier. At least one (and optionally more than one and further optionally all) stop members may be integrally formed with the body of the clamping member carrier (for example, by machining the body of the clamping member carrier, the clamping member and the stop member from one piece of metal).

At least one (and optionally more than one and further optionally all) stop member(s) may project from one or both of the body of the clamping member carrier and a respective clamping member.

At least one (and optionally more than one and further optionally all) stop member(s) may extend in a direction substantially parallel to the longitudinal axis of the clamping member carrier body.

In certain embodiments, spaces may be formed in the upper part of the clamping member carrier body proximate to a stop member. This has been found to be particularly effective when the mounting configuration comprises a screw thread. It has been found that the presence of the space decreases distortion of the clamping member carrier body.

The device may be provided with a user-operable lever arrangement, wherein at least one clamping member and the mounting portion may be movable from the non-clamping configuration to the clamping configuration by operation of the lever arrangement.

The lever arrangement may be operable to move at least one clamping member from the non-clamping configuration to the clamping configuration. At least one clamping member may be provided by a clamping member carrier which may be connected via a connector rod to a lever. The connector rod may be pivotally connected to the level so that movement of the lever causes movement of the connector rod which moves the at least one clamping member from the non-clamping configuration to the clamping configuration.

In one embodiment of the invention, the device is optionally provided with a clamping member carrier having a clamping member carrier body, the clamping member carrier body being provided with a plurality of fastener-receiving apertures. The fastener receiving apertures may be peripherally arranged around the clamping member carrier body. The mounting portion may be provided with fastener-receiving apertures which may be aligned with the fastener-receiving apertures provided in the clamping member carrier body so that fasteners may pass through the fastener-receiving apertures of the mounting portion and into the fastener-receiving apertures of the clamping member carrier body. The fasteners may secure the device to the filler neck or the fuel tank. The fastener-receiving apertures of the mounting portion and/or the clamping member carrier body may be provided with screw threads. Such screw threads would typically correspond to screw threads provided on the fasteners.

The mounting configuration of the clamping member carrier and the corresponding mounting configuration of the fuel inlet body (or tubular portion extending from the mounting portion), if present, may be arranged to permit movement from a non-clamping position to a clamping position, but resist movement from a clamping position to a non-clamping position. This may typically be achieved by providing the clamping member carrier or the fuel inlet body (or said tubular portion) with one or more protrusions which permit movement from a non-clamping position to a clamping position, but resist movement from a clamping position to a non-clamping position. Such protrusions may be in the form of barbs. The one or more protrusions provided on the clamping member carrier or the fuel inlet body (or tubular portion) may interact with a corresponding aperture, recess or the like provided on the other of the clamping member carrier or the fuel inlet body (or tubular portion) to resist movement from a clamping position to a non-clamping position.

Reference above to “the clamping member” is taken to include “at least one clamping member”, “more than one clamping member” and “all clamping members”.

In accordance with a second aspect of the present invention, there is provided a clamping member carrier suitable for use in the device of the first aspect of the present invention.

In accordance with a third aspect of the present invention there is provided a clamping member carrier for the attachment of a fuel inlet body of a fuel inlet device to a filler neck or a fuel tank, the fuel tank or filler neck comprising filler opening, a fuel tank or filler neck abutment surface and one or more projections extending inwardly into the filler opening,

the clamping member carrier comprising a substantially annular clamping member carrier body, one or more clamping members for engagement with a projection of the fuel tank or filler neck and one or more stop members for engaging with a projection of the filler neck or fuel tank so as to inhibit rotational movement of the clamping member carrier body relative to the fuel tank or filler neck.

The clamping member carrier is typically adapted to facilitate interaction with a fuel inlet body so that the fuel inlet body portion and clamping member may be urged into clamping engagement with the filler neck or the fuel tank.

The clamping member carrier may comprise those features described above with reference to the device of the first aspect of the present invention.

Those skilled in the art will realise that the fuel inlet devices described above are suitable for fitting to filler necks of a tank for containing any fluid (preferably liquids) or the tanks for containing any fluid (preferably liquids). Hence, the devices may also be referred to as fluid inlet devices or liquid inlet devices and references to “fuel” elsewhere should also be taken to mean “fluid” and in particular “liquid”.

A further embodiment of an invention may be used to address one or more of the problems associated with the prior art mentioned above. In accordance with a fourth aspect of the present invention, there is provided a fuel tank inlet device for attachment to a fuel tank or filler neck, the fuel tank or filler neck comprising a filler opening, a fuel tank or filler neck abutment surface and one or more projections extending inwardly into the filler opening,

the fuel tank inlet device comprising a clamping member and a fuel inlet body portion for the receipt of fuel, the fuel tank inlet device being provided with an inlet for the ingress of fuel, an outlet for the egress of fuel into a fuel tank and a first, clamping surface associated with the fuel inlet body portion,
the clamping member being provided with a deformable member which is arranged so that, in use, movement of the device from a non-clamping position in which the device is not attached to the fuel tank or filler neck to a clamping position in which the device is attached to the filler neck or fuel tank causes deformation of the deformable member.

This facilitates the use of a suitably-adapted male bayonet fitting to be used in relation to a fuel tank or filler neck which is not generally suitable for use with a standard male bayonet fitting. A deformable material may be placed on a surface of the clamping member, typically an upper surface.

In the clamping position, the first, clamping surface associated with the fuel inlet body portion abuts the fuel tank or filler neck abutment surface. This abutment typically forms a gas-tight seal which resists egress of gaseous fuel from a fuel tank.

It is preferred that the position of the clamping member is fixed relative to the fuel inlet body portion.

Movement from the non-clamping position to the clamping position may comprise a rotational motion.

It is preferred that the deformable member is wedge-shaped.

### DESCRIPTION OF THE DRAWINGS

The present invention will now be described by way of example only with reference to the following figures of which:

FIG. 1 is a schematic cross-section through an example of an embodiment of a device in accordance with the present invention;

FIG. 2 is a perspective view of the device of FIG. 1 showing the relationship between the fuel inlet body portion and the clamping member carrier;

FIG. 3 is a perspective view of the clamping member carrier used in the device of FIG. 1;

FIG. 4 is a perspective view of a filler neck onto which the device of FIGS. 1, 2 and 3 may be mounted;

FIG. 5A is a schematic cross-sectional view of the device of FIGS. 1 to 3 in a non-clamping position;

FIG. 5B is a schematic cross-sectional view of the device of FIGS. 1 to 3 in a clamping position;

FIG. 6 is a perspective view of a alternative embodiment of an example of a device in accordance with the present invention and

FIG. 7 shows a simplified perspective view of an alternative embodiment of a device in accordance with the fourth aspect of the present invention.

### DETAILED DESCRIPTION

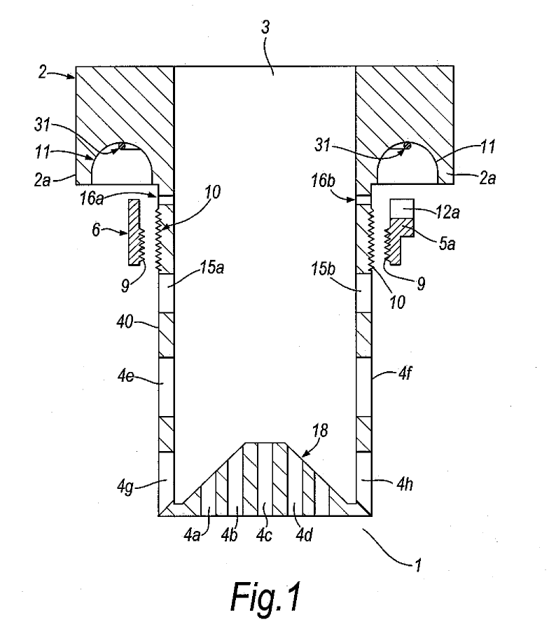

An example of an embodiment of a device in accordance with the first aspect of the present invention will now be described with reference to FIGS. 1, 2, 3 and 4.

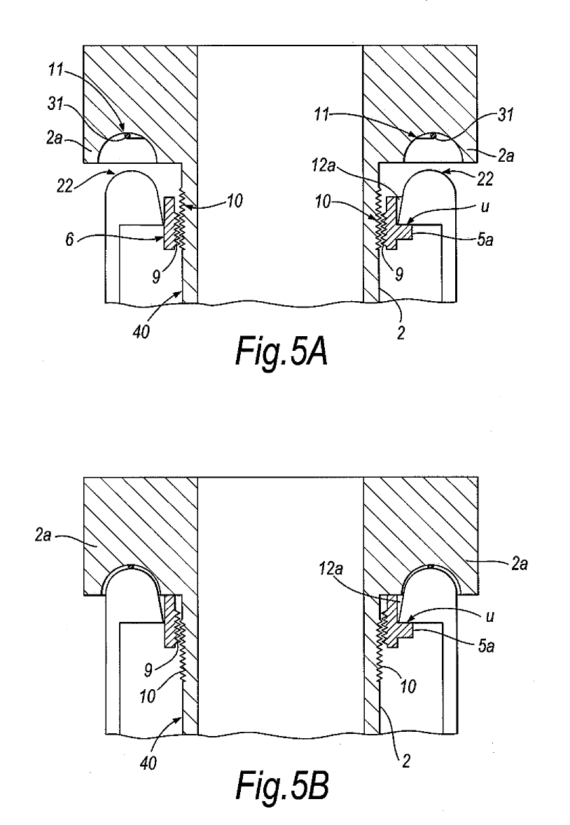

Referring to FIGS. 1, 2 and 3, the device is denoted generally by reference numeral 1 and comprises a fuel inlet body 2 for the receipt of fuel, the device comprising an inlet 3 for the ingress of fuel and an outlet for the egress of fuel into a fuel tank, the fuel tank inlet device 1 being provided with three clamping members 5a, 5b, 5c. The fuel inlet body 2 comprises a mounting portion 2a. The three clamping members 5a, 5b, 5c are provided by a clamping member carrier 6. Outlets for the egress of fuel are provided by apertures 4a, 4b, 4c, 4d, 4e, 4f, 4g, 4h. The clamping member carrier 6 comprises a substantially annular carrier body 7 which supports clamping members 5a, 5b, 5c. An internal surface 8 of the carrier body 7 is provided with a screw thread 9. The screw thread 9 is complementary to a screw thread 10 provided on the fuel inlet body 2 so that the clamping member carrier may be mounted on the fuel inlet body using screw threads 9, 10. The screw thread 10 is provided on a tubular portion 40 which projects away from the mounting portion 2a. The screw threads 9, 10 facilitate the movement of the mounting portion 2a and the clamping members 5a, 5b, 5c relative to one another from a non-clamping configuration in which the device is unattached to a fuel tank to a clamping configuration in which the device is attached to a fuel tank. In the non-clamping configuration, the clamping members 5a, 5b, 5c are remote from a first, clamping surface 11 provided by the mounting portion 2a. In the present embodiment, the first, clamping surface 11 is provided by a recess as shown schematically in FIGS. 1, 5a and 5b. The clamping surface 11 is substantially annular and is concave in cross-section (hence the clamping surface 11 may be regarded as being substantially hemitoroidal). The clamping surface 11 is for abutment with a corresponding surface of the top of a fuel tank. In the clamping configuration, each of the clamping members 5a, 5b, 5c engages a projection provided on the fuel tank and the clamping surface 11 engages with the fuel tank or filler neck sealing surface so as to secure the device to the fuel tank or filler neck.

The device will now be described in more detail with reference to FIGS. 1, 2, 3 and 4. The device is suitable for attachment to a filler neck of a fuel tank, such a filler neck being shown in FIG. 4. The filler neck is well-known to those skilled in the art. An example of a filler neck is described in U.S. Pat. No. 4,892,216, the entire contents of which are incorporated by reference. A further example of a prior art filler neck similar to that shown in FIG. 4 is typically fitted to Peterbilt trucks. The inlet region 21 of the filler neck 20 is provided with a curved (convex) surface 22 for abutting a fuel cap or other device. The curved surface is provided by a lip, the curved surface 22 being approximately hemitoroidal in shape. Three arcuate projections 23a, 23b, 23c are provided at the inlet region 21 of the filler neck 20. The projections 23a, 23b, 23c extend inwardly from the circumference of the inlet region 21. Three spaces 24a, 24b, 24c are provided between respective pairs of projections 23a, 23b, 23c.

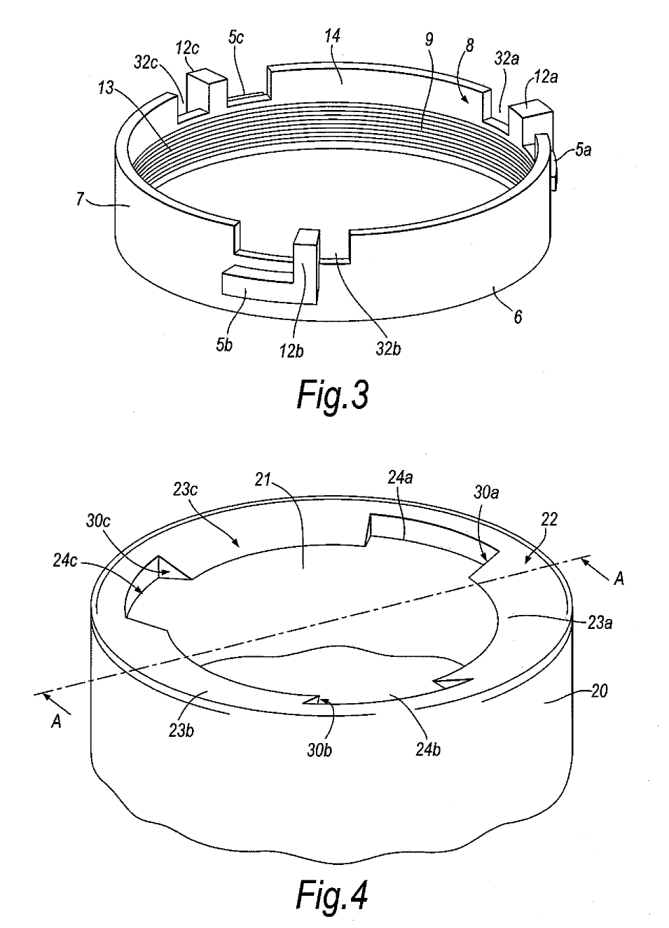

Device 1 comprises fuel inlet body 2 and clamping member carrier 6. The fuel inlet body comprises a mounting portion 2a. Clamping member carrier 6 will now be described with reference to FIG. 3. The clamping member carrier 6 comprises a clamping member carrier body 7 which provides support to the clamping members 5a, 5b, 5c. Clamping member carrier 6 also provides three stop members 12a, 12b, 12c, each stop member being associated with one of the clamping members 5a, 5b, 5c. The clamping members and stop members extend outwardly from the annular clamping member carrier body 7. The clamping members 5a, 5b, 5c are arcuate and arranged circumferentially around the outer surface of clamping member carrier body 7. Each stop member 12a, 12b, 12c projects upwardly (i.e. substantially parallel to the longitudinal axis of the annular clamping member carrier body 7). The lower portion 13 of the clamping member carrier body 7 is provided with screw thread 9 for engagement with a corresponding screw thread 10 on the fuel inlet body 2. The upper portion 14 of the clamping member carrier body 7 is not provided with a screw thread.

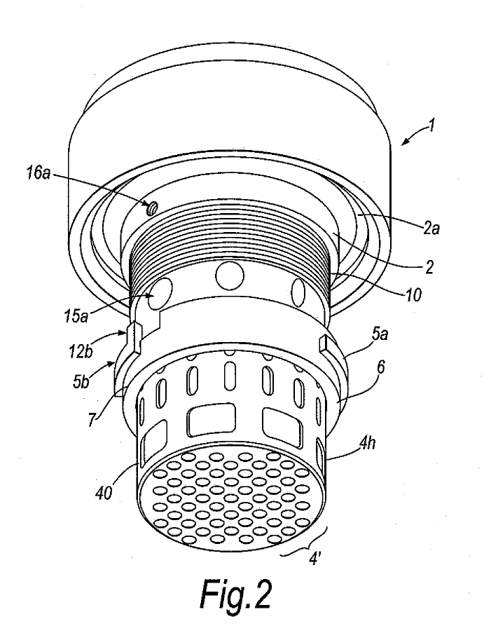

Fitting of the device 1 to the filler neck of FIG. 4 will now be described. Clamping member carrier 6 is presented to the fuel inlet body 2 of the device 1 as shown in FIG. 2, and the clamping member carrier 6 screwed onto the fuel inlet body portion 2 for two or three pitches of the threads 9, 10 so that the clamping member carrier 6 is attached to the fuel inlet body 2. The device 1 is then presented to the filler neck 20. Each clamping member 5a, 5b, 5c is inserted through a respective space 24a, 24b, 24c in the filler neck. The device 1 is then rotated in a clockwise manner (looking from above filler neck 20). This rotation of the device 1 causes rotational movement of the clamping member carrier 6 relative to filler neck 20. This rotation causes clamping members 5a, 5b, 5c to be moved from respective space 24a, 24b, 24c to a position under a respective projection 23a, 23b, 23c. The rotation also causes stop members 12a, 12b, 12c to abut against ends 30a, 30b, 30c of projections 23a, 23b, 23c. This abutment of the stop members prevents further rotation of the clamping member carrier 6. This configuration is shown schematically in FIG. 5A. FIGS. 5A and 5B are sections taken along line AA as indicated in FIG. 4, imagining that the device of FIG. 1 is fitted to the filler neck of FIG. 4.

Rotation of the fuel inlet body 2 is then continued. Because the clamping member carrier 6 is inhibited from further rotation, rotation of the fuel inlet body 2 causes further screwing of the fuel inlet body 2 onto the screw thread 9 of the clamping member carrier 6. This causes movement of the fuel inlet body 2 (including the mounting portion 2a) towards the clamping member carrier 6, and towards the top portion of the filler neck 20. The threads 9, 10 are arranged so that further rotation of the fuel inlet body 2 causes the clamping surface 11 of mounting portion 2a to be urged into abutment with surface 22 provided on the filler neck 20. Furthermore, clamping members 5a, 5b, 5c are urged into engagement with the undersides U of projections 23a, 23b, 23c so that a portion of the filler neck is clamped between surface 11 of mounting portion 2a and clamping members 5a, 5b, 5c. This configuration is shown schematically in FIG. 5B.

Mounting portion 2a is provided with an annular sealing member 31 for forming a gas-tight seal with surface 22 provided on the filler neck 20.

Referring to FIG. 3, a cut-away 32a, 32b, 32c is provided in the upper portion 14 of the clamping member carrier body 7 near to each of the clamping members and stop members. It has been discovered that an absence of material from the upper portion of the carrier body 7 is advantageous in that deformation of the carrier body is reduced when the carrier 6 is fitted to the filler neck compared to when material is not removed from the carrier body.

The clamping member carrier 6 of the present invention is manufactured by machining from a single piece of metal (typically aluminium). Those skilled in the art will realise that the stop members and clamping members need not be integral with the clamping member carrier body 7.

The device 1 is typically adapted to receive a filler cap or the like, such a cap being a conventional bayonet fitting cap (for example) or a cap such as that described in U.S. Pat. No. 4,892,216. The provision of a bayonet cap is described in International patent application no. WO2006/106238, the entire contents of which are incorporated by reference.

The device 1 once fitted to a filler neck is suitable for facilitating the introduction of fuel into the fuel tank, whilst inhibiting theft of fuel from a fuel tank. Such theft would typically occur by inserting a siphon tube into the fuel tank. The device 1 inhibits insertion of a siphon tube into the fuel tank.

The device 1 is further secured to the filler neck by use of grub screws (not shown). Once the device is in a clamped configuration as described above and as shown schematically in FIG. 5B, a grub screw is inserted through each of three threaded bores (two of which are shown as 16a and 16b (visible in FIGS. 1 and 2)) from the interior of the device 1. In the clamped configuration, the ends of the grub screws protrude through one of the cut-aways 32a, 32b, 32c and engage with the internal surface of the filler neck 20, thus providing further resistance to removal of the device 1. The use of grub screws to secure a fuel inlet device to a filler neck is disclosed in WO2006/106238.

The operation of device 1, once the device has been fitted to a filler neck, is substantially as described in WO2006/106238, but is discussed here for completeness.

A fuel nozzle (not shown) is inserted into inlet region 3 and activated. Fuel flows through outlets 4a, 4b, 4c, 4d, 4e, 4f, 4g, 4h into the fuel tank. Outlets 4a, 4b, 4c, 4d, 4e, 4f, 4g, 4h are provided in a substantially tubular portion 40 of the device, the substantially tubular portion extending away from the mounting portion 2a. Outlets 4g, 4h flare outwardly from the interior to the exterior of the device as disclosed in WO2006/106238. This flaring has been found to assist in decreasing problems with backflow. Outlets 4a, 4b, 4c, 4d are part of an array of outlets 4′ as shown in FIG. 2. This array of outlets is formed in a frusto-conical fuel deflector 18. The fuel deflector 18 diverts fuel towards outlets 4g, 4h, these outlets being located adjacent the fuel deflector. An annular barrier member (not shown) in the form of a split ring (such as a Circlip®) is provided around the circumference of the device in the region of the flared outlets 4g, 4h to inhibit ingress of a siphon tube through outlets 4g, 4h into the fuel tank. The use of such a barrier member is described in WO2006/106238.

The device 1 is provided with vent holes (two of which are labelled 15a, 15b) formed in the tubular portion, the vent holes allowing venting of gas when the fuel tank is being provided with fuel. The use of such vent holes is well-known to those skilled in the art.

In the present embodiment, the device fuel inlet body 2 is made by machining from a block of aluminium. Those skilled in the art will realise that the fuel inlet body may be made from several separate parts. Furthermore, different materials may be used.

The example of the device described with reference to FIGS. 1 to 5 is a fuel inlet device which inhibits removal of fuel from the fuel tank to which the device is fitted. The fuel inlet device need not inhibit removal of fuel.

The device 1 has many features in common with the fuel inlet device described in WO2006/106238; those skilled in the art will realise that this need not be the case. For example, it is anticipated that the example of the fuel inlet device in accordance with the present invention may comprise alternative features that have been described in relation to other fuel inlet devices (such as the float valve arrangement in GB2406333 of Tiss Limited). Such features may be readily incorporated into the device of the present invention.

The device described with reference to FIGS. 1 to 5 discloses how a clamping member carrier provided with a screw thread may be used to secure the device to a filler neck. Other arrangements are possible. For example, a lever-operated clamping mechanism as disclosed with reference to a filler cap in U.S. Pat. No. 4,892,216 may be used. Alternatively, a clamping member carrier may be used similar to that described above, but without bearing the screw thread on its inner periphery. One or more holes (optionally threaded) may be provided around the periphery of the clamping member carrier body. The threaded holes receive screws or bolts which pass through bores provided in the upper portion of the mounting portion, the heads of the screws or bolts being accessible from the top of the device so that a fitter can access the heads of the screws and bolts. Rotation of the screws or bolts causes movement of the clamping member carrier into a clamping position.

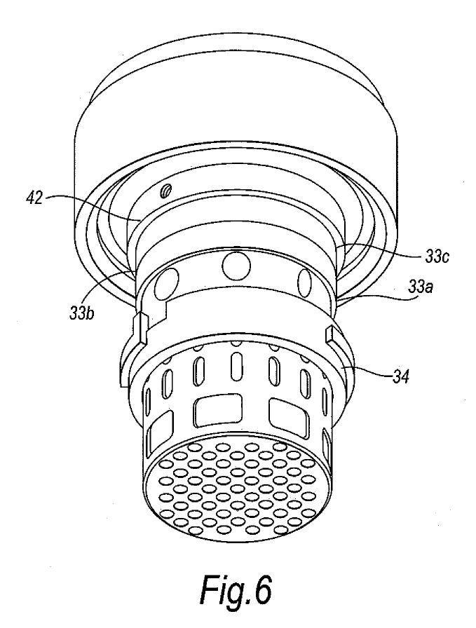

As a further alternative, barbs or projections may be provided on one or both of the clamping member carrier and the fuel inlet body to permit the body inlet portion to be urged onto the filler neck, but to inhibit removal of the device. This is shown schematically in FIG. 6. The periphery of a part of the fuel inlet body 42 is provided with a plurality of spaced annular projections 33a, 33b, 33c. The projections extend outwardly from the part of the fuel inlet body. The clamping member carrier 34 is provided with an annular recess (not shown) which engages with one of the annular projections 33a, 33b, 33c. The annular projections and recess are arranged to permit movement of the clamping member in the direction shown by the arrow, but resist movement in the opposite direction. This facilitates the device to be mounted onto a filler neck, but resists parting of the clamping member carrier and mounting portion, therefore resisting removal of the device from the fuel tank.

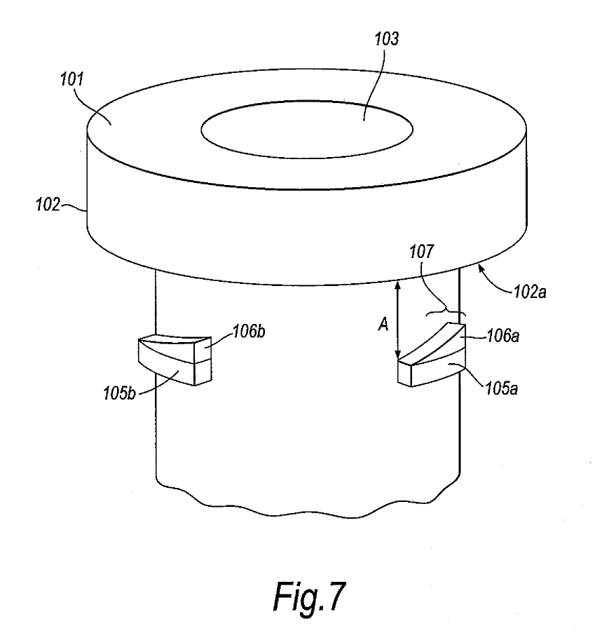

FIG. 7 shows a simplified perspective view of an alternative embodiment of a device in accordance with the fourth aspect of the present invention. The fuel inlet device is denoted generally by reference numeral 101. The device is suitable for the receipt of fuel, and comprises a fuel inlet body 102 and three lugs, two of which 105a, 105b are visible. The fuel inlet body comprises a mounting portion 102a. The lugs 105a, 105b are fixed in position relative to the mounting portion 102a, and the lugs 105a, 105b comprise conventional male parts of bayonet fittings. The use of such bayonet fittings in relation to fuel inlet devices is described in detail in WO2006/106238. Each lug is provided with a deformable member 106a, 106b. Each deformable member is wedge-shaped.

The fitting and operation of the device of FIG. 7 is now discussed with reference to FIGS. 4 and 7. Each of the respective lugs 105a, 105b is inserted downwardly through a respective space 24a, 24b, 24c. The gap, labelled A, between the leading edge of the deformable member and the underside of the top portion of the device 101 is sufficiently large to receive a respective projection 23a, 23b, 23c of the filler neck. The device 101 is then rotated, with each projection 23a, 23b, 23c being received into the gap between the deformable member and the underside of the top portion of the device. As the device 101 is rotated further, the gap between the deformable member and the underside of the top portion of the device decreases. Once the device has been fully rotated into position, at least the thicker end 107 of the deformable member has been squashed, and the clamping surface of the fuel inlet body portion has been urged into abutment with the rounded top surface 22 of the filler neck. The fuel tank inlet device is thus secured to the filler neck and is ready for the receipt of fuel through inlet 103.

Device 103 is a device for the inhibition of theft of fuel from a fuel tank.

Where in the foregoing description, integers or elements are mentioned which have known, obvious or foreseeable equivalents, then such equivalents are herein incorporated as if individually set forth. It will also be appreciated by the reader that integers or features of the invention that are described as preferable, advantageous, convenient or the like are optional.

1. A fuel tank inlet device for attachment to a fuel tank or filler neck, the fuel tank or filler neck comprising a filler opening, a fuel tank or filler neck abutment surface and one or more projections extending inwardly into the filler opening,
the fuel tank inlet device comprising a clamping member and a mounting portion, the mounting portion being provided with a first, clamping surface,
the fuel tank inlet device being provided with an inlet for the ingress of fuel and an outlet for the egress of fuel into a fuel tank
one or both of the mounting portion and the clamping member being movable relative to the other of the mounting portion and the clamping member from:
a non-clamping configuration; to
a clamping configuration in which, in use, the clamping member engages a projection and said first, clamping surface, in use, engages with the fuel tank or filler neck abutment surface so as to secure the device to the fuel tank or filler neck.

2. A fuel tank inlet device according to claim 1 wherein in the non-clamping configuration the clamping member is remote from the first, clamping surface provided by the mounting portion, and in the clamping configuration the clamping member is less remote from the first, clamping surface provided by the mounting portion.

3. A fuel tank inlet device according to claim 1 wherein the mounting portion is movable relative to the clamping member from the non-clamping configuration to the clamping configuration.

4. A fuel inlet device according to claim 1 wherein the first, clamping surface is defined by an annular recess.

5. A fuel inlet device according to claim 1 comprising the mounting portion and a substantially tubular portion extending away from the mounting portion.

6. A fuel inlet device according to claim 5 wherein the tubular portion is so that it may receive fuel from a dispensing apparatus and the substantially tubular portion is provided with one or more outlets for egress of fuel from the device into a fuel tank.

7. A fuel inlet device according to claim 1 wherein the mounting portion is provided as part of a fuel inlet body for the receipt of fuel.

8. A fuel inlet device according to claim 1 which is adapted to inhibit theft of liquid fuel from a fuel tank to which the device is attached.

9. A fuel inlet device according to claim 1 comprising a plurality of clamping members.

10. A fuel inlet device according to claim 9 wherein one or both of the mounting portion and more than one clamping member(s) are movable relative to the other of the mounting portion and the more than one clamping member(s) from the non-clamping configuration to the clamping configuration, and wherein more than one clamping member(s) is arranged to engage with a respective projection when the respective clamping member is in the clamping configuration.

11. A fuel inlet device according to claim 1 wherein at least one clamping member is provided by a clamping member carrier, at least one clamping member being in the form of a flange which projects from a body of the clamping member carrier.

12. A fuel inlet device according to claim 11, wherein the device comprises a substantially tubular portion extending away from the mounting portion, wherein the clamping member carrier is adapted to be received around the periphery of the tubular portion.

13. A fuel inlet device according to claim 12 wherein the clamping member carrier is provided with a mounting configuration for mating with a corresponding mounting configuration on the tubular portion, the mounting configuration and the corresponding mounting configuration facilitating the mounting of the clamping member carrier onto the fuel inlet body or tubular portion.

14. A fuel inlet device according to claim 13, wherein the clamping member carrier body is substantially annular, the clamping member carrier body has a longitudinal axis orthogonal to the annulus and the clamping member carrier body has a height in the direction parallel to the longitudinal axis, and the mounting configuration is not provided over the whole height of the clamping member carrier body.

15. A fuel inlet device according to claim 1 wherein the device is provided with at least one stop member for inhibiting rotational motion of the clamping member relative to the filler neck or fuel tank.

16. A fuel inlet device according to claim 1 wherein at least one clamping member is provided by a clamping member carrier, at least one clamping member being in the form of a flange which projects from a body of the clamping member carrier and wherein at least one stop member is provided by the clamping member carrier.

17. A fuel inlet device according to claim 16 wherein spaces are formed in an upper part of the clamping member carrier body proximate to a stop member.

18. A fuel inlet device according to claim 1 provided with a clamping member carrier having a clamping member carrier body, the clamping member carrier body being provided with a plurality of fastener-receiving apertures which are peripherally arranged around the clamping member carrier body, the mounting portion being provided with fastener-receiving apertures which may be aligned with the fastener-receiving apertures provided in the clamping member carrier body so that fasteners may pass through the fastener-receiving apertures of the mounting portion and into the fastener-receiving apertures of the clamping member carrier body.

19. A clamping member carrier for the attachment of a fuel inlet body of a fuel inlet device to a filler neck or a fuel tank, the fuel tank or filler neck comprising filler opening, a fuel tank or filler neck abutment surface and one or more projections extending inwardly into the filler opening,
the clamping member carrier comprising a substantially annular clamping member carrier body, one or more clamping members for engagement with a projection of the fuel tank or filler neck and one or more stop members for engaging with a projection of the filler neck or fuel tank so as to inhibit rotational movement of the clamping member carrier body relative to the fuel tank or filler neck.

20. A fuel tank inlet device for attachment to a fuel tank or filler neck, the fuel tank or filler neck comprising a filler opening, a fuel tank or filler neck abutment surface and one or more projections extending inwardly into the filler opening,
the fuel tank inlet device comprising a clamping member and a fuel inlet body portion for the receipt of fuel, the fuel tank inlet device being provided with an inlet for the ingress of fuel, an outlet for the egress of fuel into a fuel tank and a first, clamping surface associated with the fuel inlet body portion,
the clamping member being provided with a deformable member which is arranged so that, in use, movement of the device from a non-clamping position in which the device is not attached to the fuel tank or filler neck to a clamping position in which the device is attached to the filler neck or fuel tank causes deformation of the deformable member.
